(19) United States
(12) Patent Application Publication
(10) Pub. No.: US 2003/0121921 A1
(43) Pub. Date: Jul. 3, 2003

(54) Cookware

(75) Inventors: Maximillian Philip Burton, New York, NY (US); John Thomas Edmark, New York, NY (US)

Correspondence Address: Randy J. Pritzker, Wolf, Greenfield & Sacks, P.C., 600 Atlantic Avenue, Boston, MA, 02210, US

(73) Assignee: World Kitchen, Inc., Elmira, NY

(21) Appl. No.: 10/301,534

(22) Filed: Nov. 21, 2002

Related U.S. Application Data
(60) Provisional application No. 60/334,206, filed on Nov. 28, 2001.

(51) Int. Cl. B65D 51/16; A47J 27/00

(52) U.S. Cl. 220/366.1; 220/912

(57) ABSTRACT

A lid for a cooking vessel may be placed in different rotational positions to adjust the amount of venting or provide for pouring. The lid may have different radius lengths for different edge portions. A cooking vessel rim may have corresponding radius lengths such that the lid may be placed on the cooking vessel in a venting or non-venting position.

### RELATED APPLICATIONS

This application claims the benefit of U.S. Provisional Application 60/334,206 under 35 U.S.C. §119(e), filed Nov. 28, 2001, entitled “COOKWARE,” by Burton et al. The entirety of the above provisional application is hereby incorporated by reference.

### FIELD OF THE INVENTION

This present invention relates generally to vessels for holding food products, and more specifically to cookware that allows for selective venting and/or pouring.

### BACKGROUND OF THE INVENTION

When using a pot or other cooking vessel, it is often desirable to cover the pot to limit the escape of steam, water vapor, or heat. A removable lid may cover the pot to prevent steam from escaping and, when desired, may be removed to allow the steam to escape. In some cases, it may be desirable to allow a certain amount of steam to escape without completely uncovering the pot. Typically, available options include tilting the lid precariously in the pot or placing the lid slightly off-center on top of the pot. In both cases, the lid may fall off of the pot or the lid edges may dip into the pot and contact the contents of the pot.

### SUMMARY OF THE INVENTION

One aspect of the present invention provides a number of embodiments of cooking vessels and/or vessel lids that allow for venting or pouring. Another aspect of the invention provides a method for venting a cooking vessel. The radii and/or the rim height of the vessel and the lid can vary for different perimeter portions and be configured to allow for the selective venting of the cooking vessel.

According to one embodiment, a lid for a cooking vessel comprises a central portion and an edge forming a curved perimeter around the central portion, the perimeter having first, second and third arcs that define first, second and third lid sectors with central angles of greater than or equal to sixty degrees each. The first and third lid sectors have radii larger than the radius of the second lid sector.

According to another embodiment, a lid for a cooking vessel comprises a central portion and a rim substantially surrounding the central portion, the rim having first, second, third and fourth sections that extend at an angle from the central portion to corresponding rim edges. The first and third rim edges are displaced vertically from the second and fourth rim edges when the lid is horizontal.

In yet another embodiment, a cooking vessel comprises a base, a wall having at least four wall sections, and a rim that extends around an upper portion of the wall and angles outwardly from the wall. The rim starts angling outwardly from the wall at a first height of the wall in at least two of the wall sections, and the rim starts angling outwardly from the wall at a second, greater height of the wall in at least two of the remaining wall sections.

In another embodiment of the invention, a cooking vessel comprises a base, a wall having at least four wall sections, and a rim that extends around an upper portion of the wall. The rim extends to a first height in at least two of the wall sections, and the rim extends to a second, greater height in at least two of the remaining wall sections.

In yet another embodiment of the invention, a cooking apparatus comprises a cooking vessel having a rim defining an opening, and a lid for covering at least a portion of the opening, the lid having a center axis and a circumferential lid edge including at least four outer edge portions of greater than 40° each. The horizontal distance from a first point on the center axis to one outer edge portion differs from each of the horizontal distances from the first point to each of two adjacent outer edge portions. The lid is rotatable relative to the vessel to form upwardly facing gaps between the lid edge and the vessel rim.

Other aspects of the invention will be apparent from the detailed description below and the claims. It will be apparent to those of skill in the art that the various aspects of the invention discussed above and described below in the detailed description may be combined in any suitable manner.

### BRIEF DESCRIPTION OF THE DRAWINGS

The invention will be appreciated more fully with reference to the following detailed description of illustrative embodiments thereof, when taken in conjunction with the accompanying drawings, wherein like reference characters denote like features, in which:

FIG. 1 is a top perspective view of a lid in a non-venting position on a pot according to one illustrative embodiment of the invention;

FIG. 2 is a top perspective view of the embodiment of FIG. 1 with the lid in a venting position on the pot;

FIG. 3 is a cross-sectional view of the lid placed on the pot according to one embodiment of the invention;

FIG. 4 is a top view of the lid shown in FIGS. 1-3;

FIG. 5 is a top view of the pot shown in FIGS. 1-2;

FIG. 6 is a top view of a pot according to another illustrative embodiment of the invention;

FIG. 7 is a cross-sectional view of the pot of FIG. 6 taken along cross-sectional line 7A; a cross-sectional view of the pot rim taken along cross-sectional line 7B is shown with broken lines;

FIG. 8 is a top perspective view of the pot shown in FIGS. 6-7;

FIG. 9 is a cross-sectional view of the lid taken along line 9-9 of FIG. 4;

FIG. 10 is a cross-sectional view of the lid taken along line 10-10 of FIG. 4;

FIG. 11 is a cross-sectional view of the pot taken along line 1 1-11 of FIG. 5;

FIG. 12 is a cross-sectional view of the pot taken along line 12-12 of FIG. 5; and

FIG. 13 is a top view of yet another embodiment of a lid.

### DETAILED DESCRIPTION

Illustrative embodiments of the invention provide a cooking vessel and a corresponding lid which is placed on the vessel and can be rotated with respect to the vessel to provide varying degrees of venting. According to one aspect of the invention, the cooking vessel and lid may be configured such that the vessel can be vented without removing the lid from the vessel. According to another aspect of the invention, the vessel and lid combination may allow for controlled pouring of the cooking contents without removal of the lid. It is also contemplated that the vessel and lid may be used to strain the contents as they are poured.

According to another aspect of the invention, the configuration of the lid and cooking vessel may provide for venting gaps that face upwardly when the cooking vessel is placed on a horizontal surface. The upwardly facing vent gaps may be helpful in allowing steam or water vapor to escape from the top of the cooking vessel. The lid and cooking vessel may also be configured to provide venting gaps that direct the steam to vent outwardly from the vessel at an angle relative to the lid.

In one illustrative embodiment of the invention, a lid with a rim is placed on top of a cooking vessel such that the lid rim nests in an outwardly flared rim of the top of the vessel. When the lid is rotated relative to the vessel, the lid rim and the vessel rim form gaps to allow for venting and/or pouring. In some embodiments, the length of the gap around the perimeter of the vessel is adjustable, while in other embodiments, there may be a limited number of selectable gap lengths.

According to another aspect of the invention, a handle is positioned on the lid such that when the lid is positioned in a pouring/venting position, a user can press on the lid handle with his or her thumbs while holding side handles of the cooking vessel. In this regard, the user can pour liquid contents of the vessel without heat or steam venting in the direction of his or her hands.

In one illustrative embodiment, the lid has two or more perimeter portions along its edge. Some of the perimeter portions are spaced further from a center of the lid than others of the perimeter portions. In this regard, the radius of the lid from the center to the edge varies for different perimeter portions. The vessel as well may have two or more rim portions wherein the radius of the vessel, extending from the center of the vessel to the edge of the vessel, varies for different rim portions. In a “non-venting” position, the perimeter portions of the lid mate with corresponding vessel rim portions such that there is substantially no gap from which the steam can escape. However, when the lid is rotated relative to the vessel, certain of the lid perimeter portions do not mate with corresponding vessel rim portions, and a gap is formed along certain portions of the lid/vessel interface. For example, when the lid is rotated, a smaller lid radius may overlie a larger vessel radius along a portion of the perimeter, and thus the lid rim will not reach an inner side of the vessel rim along that perimeter portion, leaving a gap at the top of the vessel. In another example, the vessel has certain rim portions which are higher than other rim portions. When rotated, perimeter portions of the lid having a smaller radius may be raised above the vessel rim and thus form a gap. It should be noted that a non-venting position does not necessarily imply that no steam or water vapor can escape from the vessel. Similar to typical pots or other vessels, a lid that substantially covers the vessel may nonetheless allow some venting due to pressure buildup or small gaps between the lid and vessel.

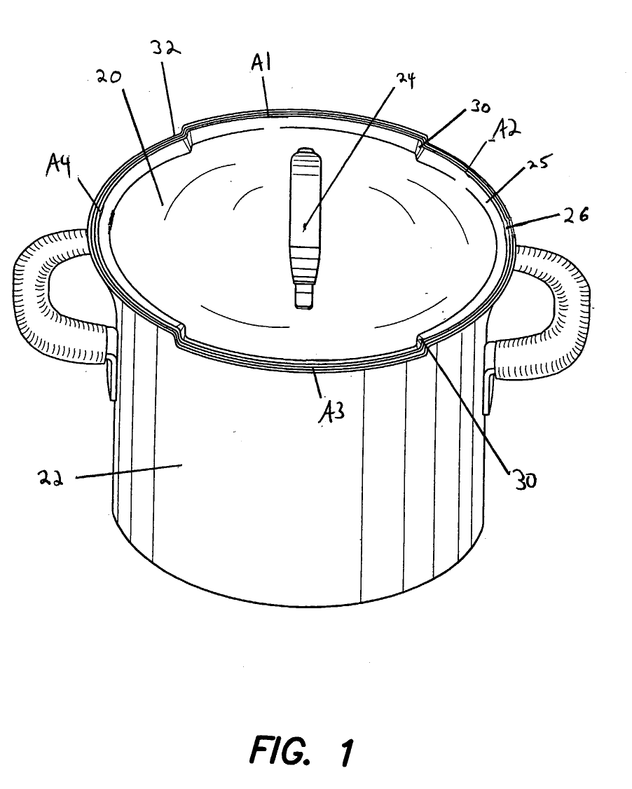

A lid 20 is shown nested in a pot 22 in the illustrative embodiment shown in FIG. 1. Lid 20 has a center point 24, a rim 25, and an edge 26 of lid 20 that has four perimeter portions shown as four arcs A1, A2, A3, A4 in the embodiment of FIG. 1. In the illustrated embodiment, the radius length from lid center point 24 to each perimeter portion is one of two radius lengths. The lid radii extending to arcs A1 and A3 are larger than the lid radii that extend to adjacent arcs A2 and A4. The lid radii extending to arcs A1 and A3 are equal to each other, as are the lid radii extending to arcs A2 and A4. Of course, perimeter portions opposite from each other need not have equal radii, and in some embodiments lid 20 may have several different radii. In the embodiment shown in FIG. 1, each perimeter portion occupies ninety degrees, or one-quarter, of the perimeter. The lid 20 may of course have perimeter portions that occupy different fractions of the lid perimeter, and the perimeter portions need not be equal to each other in the fractions that they occupy. For purposes herein, a curved perimeter is defined as a perimeter having a curved portion located anywhere within the perimeter. In some embodiments, the curved perimeter is curved along substantially the entirety of the perimeter, while in other embodiments the curved perimeter is curved only along selected portions of the perimeter.

A top opening in the pot (covered by the lid in FIG. 1) has radii (extending from a center of the pot opening to a pot rim 32) that correspond to the lid radii. When placed in the illustrated rotational position such that the corresponding radii align with each other, lid 20 nests with pot rim 32 to substantially cover the pot opening in a non-venting position. When the lid 20 is rotated a half turn (180 degrees), the lid 20 will again nest with the pot rim 32 in a non-venting position. Various other rotation angles will result in venting positions.

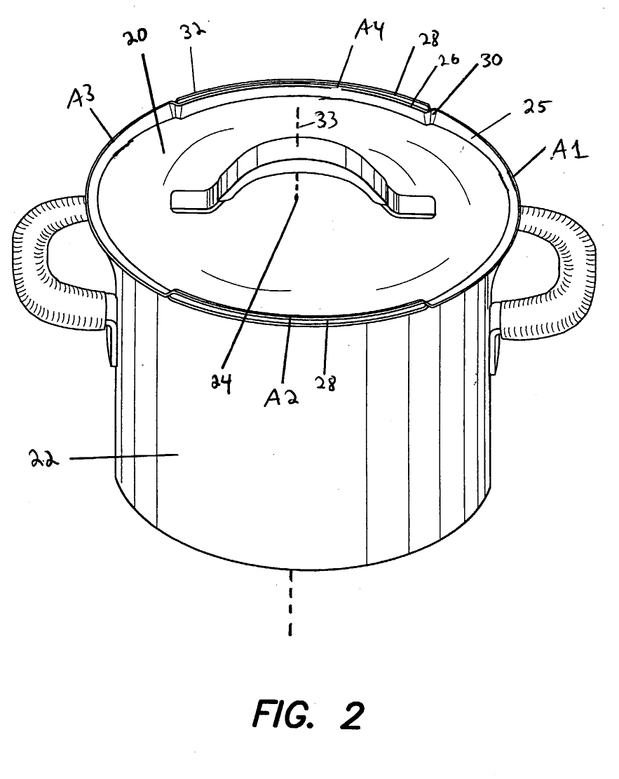

FIG. 2 shows the lid 20 of FIG. 1 rotated clockwise ninety degrees to a full “venting” position. In this position, the smaller radii of lid 20 (arcs A2 and A4) are rotated to align with the larger radii of the pot opening. Because the lid radii are smaller than the pot opening radii for these perimeter portions, gaps 28 are present between the lid edge 26 and the pot rim 32 along the corresponding lid perimeter portions A2 and A4. The gaps 28 allow steam or water vapor to escape during cooking, and may also be used for dispensing contents of the pot.

Still referring to FIGS. 1 and 2, in one embodiment, the lid 20 may be rotated without entirely removing the lid 20 from the pot 22. Transition zones 30 between the perimeter portions allow the lid 20 to be turned and gradually lifted as the larger radius portions of the lid 20 are rotated into the smaller radius portions of the pot 22. In other embodiments, the transition zones 30 may be more abrupt, and the lid 20 may be lifted slightly before rotating. In one embodiment, the transition zone may be perpendicular to the lid edge. In other embodiments, the change from one radius to another may be more gradual, or may include a number of stepped changes in radius length.

In instances when more venting is desired than can be provided by placing the lid in the position shown in FIG. 2, the lid 20 may be rotated by less than ninety degrees which will result in longer lengths of gaps 28. For example, if the lid 20 is rotated forty-five degrees clockwise from the non-venting position shown in FIG. 1, gaps 28 will be present along the entire perimeter of the lid 20 except where arcs A1 and A3 are aligned with vessel rim portions having smaller radii. It is contemplated that in some embodiments, the radius from center 24 to the edge of a lid perimeter portion will vary within that perimeter portion. For example, the radius of the lid 22 may progressively change between two transition zones 30.

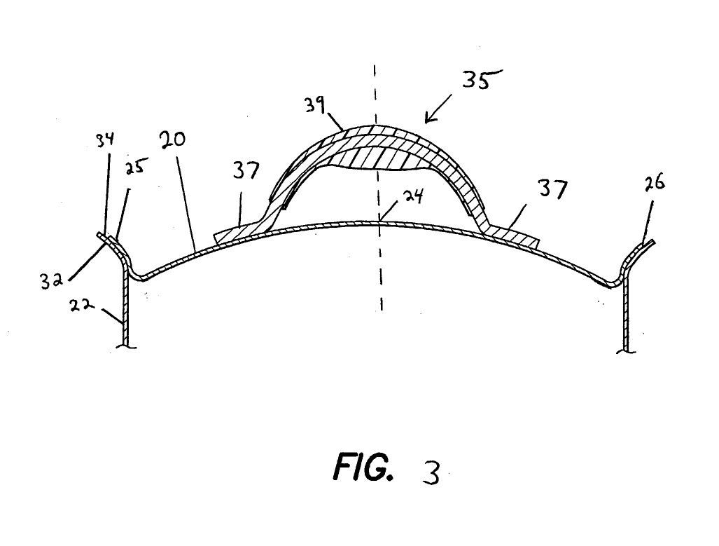

Referring to FIG. 3, lid 20 is shown on pot 22 in a cross-sectional view. The lid rim 25 is shown resting on an inner side 34 of the pot rim 32. In this position, lid 20 and pot 22 substantially prevent steam from venting. In this embodiment, lid rim 25 contacts the inner side 34 of the pot rim 32 along a length in the direction of pot rim 32. It should be understood that the lid may contact the pot rim along a smaller or larger length in the direction of the rims or even at a single point. In some embodiments, the lid may interlock or dovetail with the pot rim.

A lid handle 35 is attached to lid 20 at two lid handle ends 37. A coating 39, such as silicone rubber, covers handle 35 to provide heat insulation and/or a comfort grip. Coating 39 may be formed of any suitable coating and may extend over the lid handle ends 37.

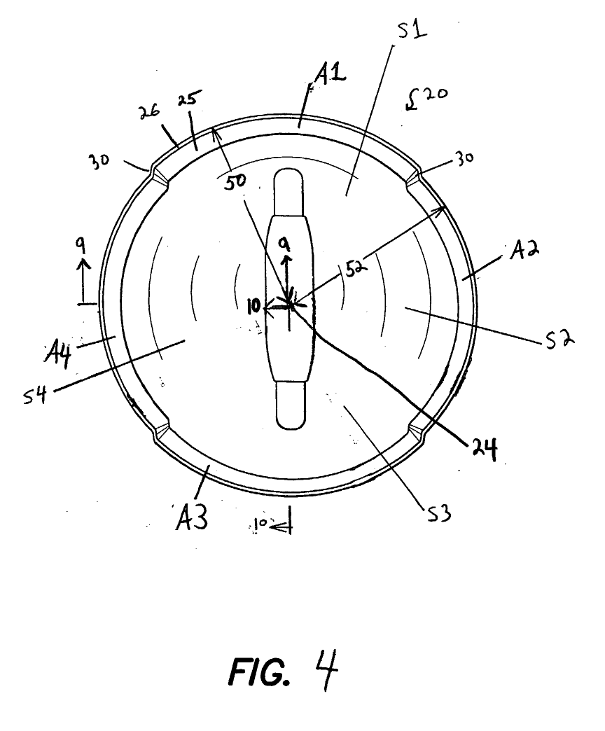

A top view of a lid having different radii is shown in FIG. 4. Lid 20 has a first radius 50 extending to the edge 26 of lid 20 from center point 24. Lid 20 also has a second radius 52 that is shorter than first radius 50. In the embodiment shown in FIG. 4, the radius of lid 20 directly opposite radius 50 has the same length as radius 50. However, opposed radii do not necessarily have to be equal in length. Accordingly, for each of the perimeter portions, shown as arcs A1, A2, A3, A4 in the FIG. 4 embodiment, lid 20 may have a different radius.

Arcs A1, A2, A3, A4 define four lid sectors S1, S2, S3, S4, each composing one-fourth of lid 20 and having a central angle of ninety degrees. For example, an outer boundary of lid sector S1 extends from center point 24 to the transition zone 30 on the left side of arc A1, to the transition zone 30 on the right side of arc A1, and back to center point 24. FIG. 5 shows one embodiment of a cooking vessel for use with lid 20. Similar to lid 20, pot 22 of this embodiment has radii of different lengths. In two sectors of pot 22, a radius 60 extends from center axis 33 to rim 32 and has a greater length than a second radius 62. Pot 22 is sized such that radii 50 and 52 of lid 20 can nest in radii 60 and 62 of pot 22.

When lid 20 is nested with pot 22 such that lid radius 50 is aligned with pot radius 60 and lid radius 52 is aligned with pot radius 62, lid 20 is in a non-venting, or closed position. As discussed above, a non-venting position does not necessarily imply that zero venting is possible. Rather, some venting may occur through small gaps or due to vapor pressure moving the lid. Turning lid 20 ninety degrees results in lid radius 50 aligning with pot radius 62. Because pot radius 62 is smaller than lid radius 50, lid rim 25 is supported at a higher level on the pot rim 32 than when in the non-venting position. With lid rim 25 supported at a higher level, a gap is formed between lid rim 25 and pot rim 32 in sectors where smaller lid radius 52 is aligned with larger pot radius 60.

Side handles 55 are position on pot 22 such that when lid 20 is placed in the venting position, the user can lift pot 22 with the side handles while simultaneously pushing on the lid handle ends 37 with his or her thumbs. Other handles may be used with other types of cooking vessels such as frying pans or sauce pans. Side handles 55 can optionally be covered, partially or in full, with silicone rubber or other suitable material for thermal and/or comfort purposes.

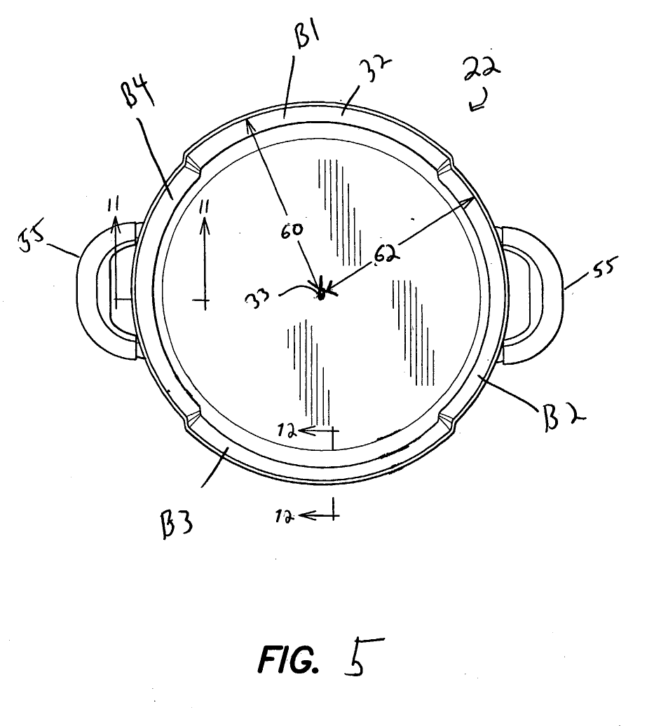

Another embodiment of a cooking vessel for use with a lid to allow selective venting is illustrated in FIGS. 6-8. Similar to pot 22 of the FIG. 5 embodiment, pot 23 is shown with four sectors and transition zones 30 between adjacent sectors. The embodiment of pot 23 in FIG. 6, however, includes a pot rim 32 that has different heights in different sectors. In this embodiment, edges of pot rim 32 are substantially equidistant from center axis 33 regardless of sector.

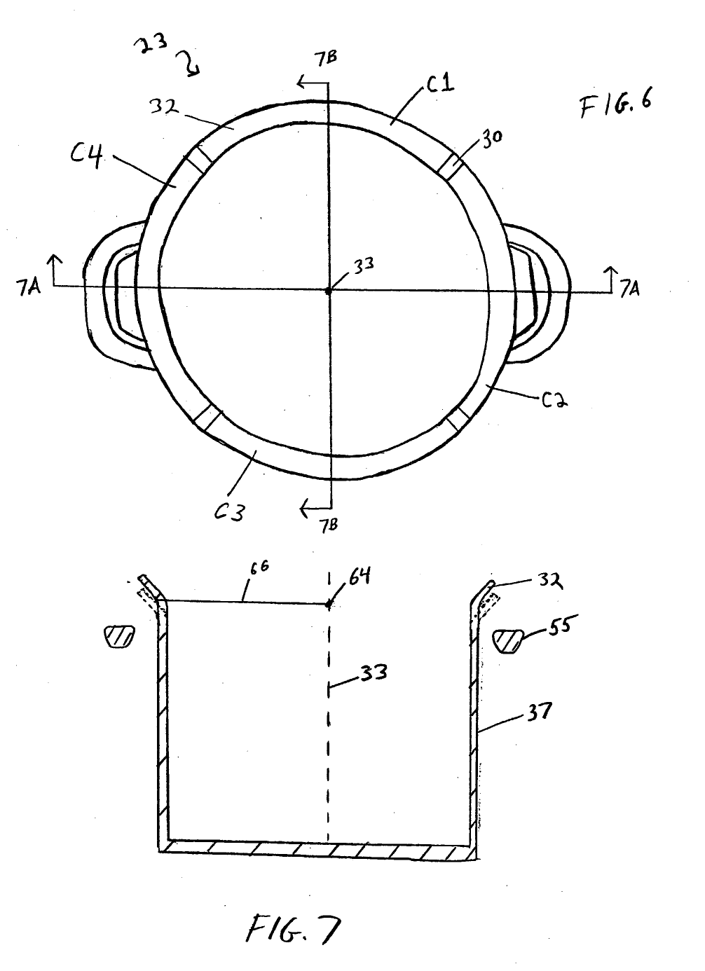

FIG. 7 shows pot rim 32 of cross-section 7A of FIG. 6 in solid and pot rim 32 of cross-section 7B in broken lines. In this embodiment, pot rim 32 is disposed at a greater height in sections C2 and C4 than in sections C1 and C3. When lid 20 is placed on pot 23 such that arcs A1 and A3 are positioned on rim sections C1 and C3, lid 20 is in a non-venting position. When lid 20 is rotated ninety degrees, lid arcs A1 and A3 are supported by Sectors C2 and C4 of pot rim 32. The greater height of pot rim 32 in sections C2 and C4 prevents lid arcs A2 and A4 (lid arcs A2 and A4 correspond to the smaller radii of lid 20) from reaching sections C1 and C3 of pot rim 32, thereby leaving a gap for venting or pouring. The embodiment illustrated in FIGS. 6-8 has a pot rim 32 that angles outwardly from the vessel wall 37 at the same angle regardless of the height at which the rim starts angling outwardly. In other embodiments, the pot rim may angle outwardly at different angles depending on the height at which the rim starts angling outwardly. In still further embodiments, the angle of the pot rim may vary within a section on the angle of the rim within transition zones 30 may be different than the rim angle outside of transition zones 30. In still further embodiments, the rim may not angle outwardly from the vessel wall, but rather extend straight up to a certain height as a continuous extension of the vessel wall.

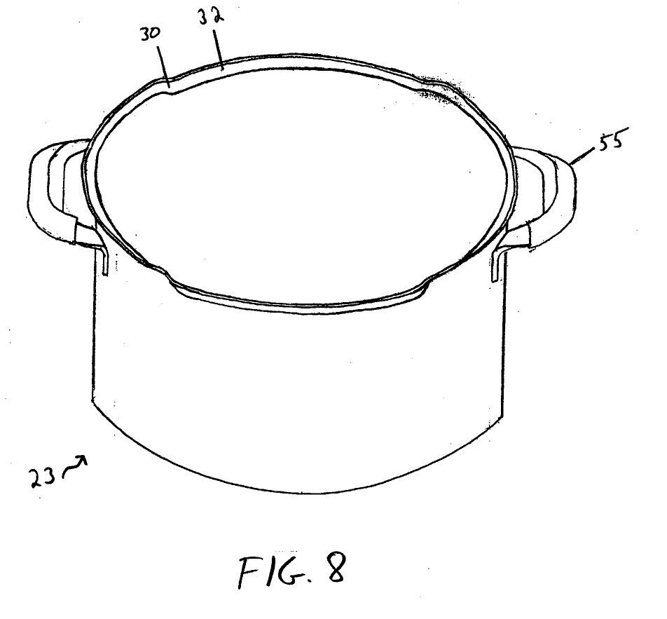

FIG. 9 shows a cross-section of half of lid 20 in a smaller radius sector along line 9-9 of FIG. 4. Lid 20 includes a central portion 36, rim 25, and a connecting portion 38 between central portion 36 and rim 25. FIG. 10 shows a cross-section of half of lid 20 in a larger radius to sector along line 10-10 of FIG. 4. An outer surface 40 of the rim 25 is constructed and arranged to rest on the inner side 34 of the pot rim 32 (see FIG. 3). The connecting portion 38 may be shaped such that it provides an interference fit with the pot rim 32 or the pot 22 itself. The shape and/or dimensions of the larger radius lid portions may be different than those of the smaller lid portions, or the shape and dimensions may be similar.

In alternate embodiments, there may be no connecting portion 38 between central portion 36 and rim 25. For example, central portion 36 may abruptly change to an upwardly sloping rim 25. In still further embodiments, rim 25 may not slope upwardly. For example, the outer part of central portion 36 may extend to the edge 26 of the lid 20 without any significant change in the slope or direction of the lid 20.

The central portion 36 of the lid is shown in FIGS. 9 and 10 as a curved surface that slopes downwardly from center point 24 to connecting portion 38. As should be evident to one of skill in the art, the lid may be any suitable shape, such as, for example, a surface that extends linearly from the center point 24 to the lid edge 26, a horizontal surface, or a surface that changes slope at several different locations along the central portion.

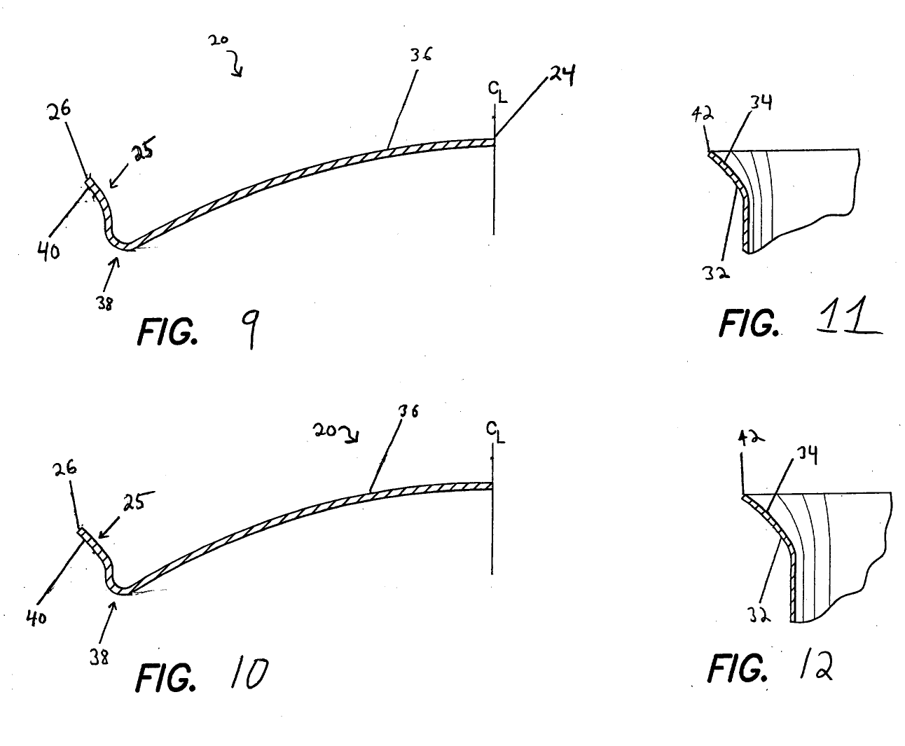

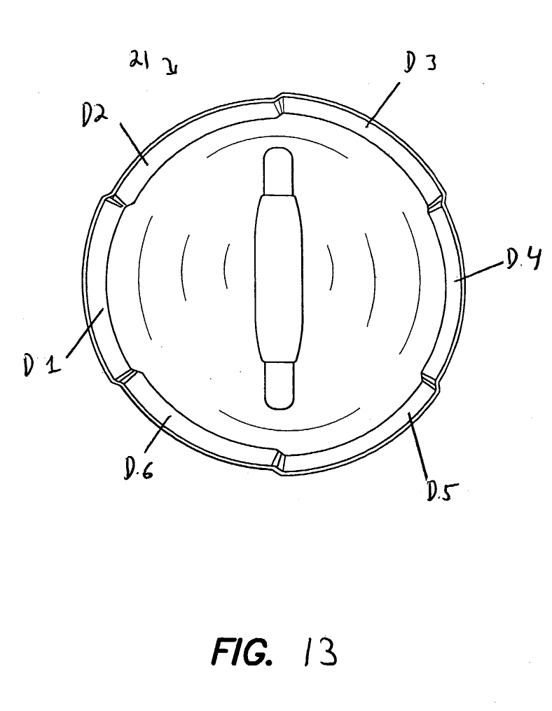

Cross-sectional views of one embodiment of the pot rim 32 are shown in FIGS. 11-12. FIG. 11 shows a flared rim 32 of the pot in a cross-section of a shorter radius sector of the pot 22. The outer surface 40 of lid edge 26 may rest on the inner surface 34 of pot rim 32. The inner surface 34 of pot rim 32 may include several indentations (not shown) or may include a continuous horizontal slot (not shown) that extends horizontally. A horizontal slot may help to hold a lid that does not have an upwardly sloping edge portion.

The lid 20 and/or the pot 22 may have protuberances or indentations (not shown) to loosely hold the lid in certain rotational positions. For example, an indentation may be positioned in the pot rim 32 thirty degrees and sixty degrees from a transition zone. Corresponding protuberances may be positioned on the lid edge 26. When the protuberances are aligned with the indentations, the lid 20 may be more resistant to rotation and/or removal from the pot 22. Of course, such lid holders are not required, and the lid edge may have a smooth and continuous surface.

When in the venting position, pot 22 and lid 20 may be tilted to pour contents from the pot 22. One of the gaps 28 allows contents of the pot to be poured or otherwise dispensed without complete removal of the lid 20. The gap 28 may help to control the quantity, rate, and/or direction of the pouring. The lid 20 may be maintained in contact with the pot 22 either by the user holding the lid 20 against the pot 22 or by an attachment mechanism (not shown) between the lid and the pot 22. In some embodiments, straining of the contents while pouring may be possible. For example, if the gap 28 is smaller than solid foodstuffs present in the pot 22, tipping the pot 22 with the lid 20 in a venting position may pour out liquids while holding solids in the pot 22. In another embodiment, a mesh or a strainer having perforations (not shown) may be incorporated into the lid 20 and/or the pot 22 to provide for straining of the contents when pouring.

In some embodiments, the pot rim 32 is not flared. Instead, the pot rim 32 may extend linearly to an outer edge 42 of the rim 32. In some cases, such as with a stock pot, the pot rim 32 may be entirely vertical and a lid 20 with a sloping edge portion 26 may be rested on the pot rim 32.

The lid embodiments shown in FIGS. 1-4 include four arcs A1, A2, A3, A4. In other embodiments, the lid may have other suitable numbers of arcs. For example, the lid may have six arcs and the pot may have six rim sections. FIG. 13 shows a lid 21 with six arcs D1, D2, D3, D4, D5, D6. In this embodiment, rotating lid 21 by sixty degrees will place the lid in a venting position. In other embodiments, the lid may have a different number of arcs than the pot has rim sections.

Cooking vessels other than the illustrated pots may be used. For example, frying pans, saute pots, saucepans, or any other suitable type of cooking vessel may be used. The cooking vessel and/or lid may be made from any suitable construction material, such as stainless steel, iron, aluminum, glass, or a combination of suitable materials. Various handles for the lid and cooking vessel may be used. Aspects of the above-described embodiments may also be incorporated into vessels that are not used exclusively for cooking. For example, containers or vessels used to keep food warm or cold may also have lids or covers that allow for selective venting of the interior of the container for moisture or heat control purposes.

Having described several illustrative embodiments of the invention in detail, various modifications and improvements will readily occur to those skilled in the art. Such modifications and improvements are intended to be within the scope of the invention. Accordingly, the foregoing description is by way of example only and is not intended as limiting. The invention is limited only as defined by the following claims and the equivalents thereto.

What is claimed is:

1. A lid for a cooking vessel, comprising:
a central portion; and
an edge forming a curved perimeter around the central portion, the perimeter having first, second and third arcs that define first, second and third lid sectors with central angles of greater than or equal to sixty degrees each, the first and third lid sectors having radii larger than the radius of the second lid sector.

2. The lid of claim 1, wherein the edge has a fourth arc that defines a fourth lid sector; and wherein the first and third lid sectors have radii larger than the radii of the second and fourth lid sectors.

3. The lid of claim 2, wherein each of the first and third lid sectors has a central angle of about ninety degrees.

4. The lid of claim 3, wherein the first lid sector has a radius equal to the radius of the third lid sector.

5. The lid of claim 4, wherein the second lid sector has a radius equal to the radius of the fourth lid sector.

6. The lid of claim 2, further comprising a longitudinal handle attached to the lid and having two ends, the two handle ends attached to the lid within the first and third sectors.

7. The lid of claim 1, further comprising a rim that slopes upwardly from the central portion to the edge.

8. The lid of claim 7, wherein the rim slopes upwardly at the same angle along substantially the entire perimeter.

9. The lid of claim 7, wherein the rim slopes upwardly at different angles along different arcs of the perimeter.

10. A lid for a cooking vessel, comprising:
a central portion; and
a rim substantially surrounding the central portion, the rim having first, second, third and fourth sections that extend at an angle from the central portion to corresponding rim edges;
wherein the rim edges of the first and third rim sections are displaced vertically from the second and fourth rim sections when the lid is horizontal.

11. The lid of claim 10, wherein the rim extends upwardly from the central portion.

12. The lid of claim 1 1, wherein the rim edges of the first and third rim sections are higher than the edges of the second and fourth rim sections when the lid is horizontal.

13. The lid of claim 12, wherein the rim edge of the first rim section is at the same height as the rim edge of the third rim section and the rim edge of the second rim section is at the same height as the rim edge of the fourth rim section when the lid is horizontal.

14. The lid of claim 13, further comprising a handle having two ends, wherein the two handle ends are attached to the lid within first and third lid sectors defined by the first and third rim sections.

15. The lid of claim 10, wherein the first, second, third and fourth rim sections define first, second, third and fourth lid sectors, the first and third lid sectors having radii larger than the radii of the second and fourth lid sectors.

16. A cooking vessel, comprising:
a base;
a wall having at least four wall sections; and
a rim that extends around an upper portion of the wall and angles outwardly from the wall;
wherein the rim starts angling outwardly from the wall at a first height of the wall in at least two of the wall sections and the rim starts angling outwardly from the wall at a second, greater height of the wall in at least two of the remaining wall sections.

17. The cooking vessel of claim 16 wherein the rim angles outwardly from the wall at a substantially constant angle.

18. The cooking vessel of claim 17, wherein a distance from a center axis of the cooking vessel to an outer edge of the rim is substantially the same for the entire rim.

19. The cooking vessel of claim 18, wherein the wall is substantially cylindrical.

20. The cooking vessel of claim 19, further comprising the handles attached to the vessel within two of the at least two wall sections that include the rim that starts angling outwardly from the wall at the second, greater height.

21. A cooking vessel, comprising:
a base;
a wall having at least four wall sections; and
a rim that extends around an upper portion of the wall;
wherein the rim extends to a first height in at least two of the wall sections and the rim extends to a second, greater height in at least two of the remaining wall sections.

22. The cooking vessel of claim 21 wherein the rim angles outwardly from the wall.

23. The cooking vessel of claim 22, wherein a distance from a center axis of the cooking vessel to an outer edge of the rim is substantially the same for the entire rim.

24. The cooking vessel of claim 23, wherein the wall is substantially cylindrical.

25. The cooking vessel of claim 24, further comprising the handles attached to the vessel within two of the at least two wall sections that include the rim that extends to the second, greater height.

26. A cooking apparatus comprising:
a cooking vessel having a rim defining an opening; and
a lid for covering at least a portion of the opening, the lid having a center axis and a circumferential lid edge including at least four outer edge portions of greater than 40 degrees each;
wherein the horizontal distance from a first point on the center axis to one outer edge portion differs from each of the horizontal distances from the first point on the center axis to each of two adjacent outer edge portions; and
the lid is rotatable relative to the vessel to form upwardly facing gaps between the lid edge and the vessel rim.

27. The cooking apparatus of claim 26, wherein:
the cooking vessel has a vessel center axis and four rim portions with inner surfaces; and
the horizontal distance from a first point on the vessel center axis to the inner surface of one rim portion differs from each of the horizontal distances from the first point on the vessel center axis to the inner surfaces of each of two adjacent rim portions.
